(19) United States
(12) Patent Application Publication
(10) Pub. No.: US 2019/0100130 A1
(43) Pub. Date: Apr. 4, 2019

(54) LED TRAILER HITCH

(71) Applicants: Bradley Banks, Anaheim, CA (US); Cody Arneson, Norco, CA (US)

(72) Inventors: Bradley Banks, Anaheim, CA (US); Cody Arneson, Norco, CA (US)

(21) Appl. No.: 16/152,149

(22) Filed: Oct. 4, 2018

Related U.S. Application Data
(60) Provisional application No. 62/568,147, filed on Oct. 4, 2017.

(51) Int. Cl. B60Q 1/26

(52) U.S. Cl. CPC B60Q 1/2661; B60D 1/36

(57) ABSTRACT

The present invention is directed to an interchangeable, modular, trailer hitch system which incorporates an LED light assembly built into the hitch assembly. The LED lighting assembly may be wired directly into the towing vehicle's backup lighting system or it may be provided with an on-off switch which may be positioned inside the tow vehicle or outside the tow vehicle near where the hitch is mounted on the vehicle.

Central to the present invention is a LED light housing which mounts to the shank of the trailer ball mount. The shank is inserted through an aperture in the light housing and the light housing is rigidly connected to the shank by means of bolts which are inserted through openings in the top of the light housing and screwed into corresponding threaded bolt holes in the upper surface of the shank. Once the light housing is secured to the shank the shank can be inserted into the hitch receiver and locked in place in the standard manner.

This present invention generally relates to trailer hitches and more particularly relates to a trailer hitch having built in lights which provide for a greater efficiency and safety when being used at night or other times of reduced visibility.

### BACKGROUND

The standard trailer hitch is not provided with a lighting means to illuminate the tongue of the trailer when the user is attempting to connect the hitch to the trailer at night when it is dark or at the other times of reduced visibility. The standard backup lights on a typical pickup truck or other tow vehicle do not provide an adequate amount of illumination when the user is attempting to back up to the trailer in poor lighting conditions. This necessitates several attempts before the hitch is properly lined up with the trailer tongue or it requires the presence of a second individual to hold a light source on the trailer. A need therefore exists to provide a solution to these shortcomings in previous trailer hitches. The present invention addresses this and other needs.

### SUMMARY OF THE INVENTION

The present invention is directed to an interchangeable, modular, trailer hitch system which incorporates an LED light assembly built into the hitch assembly. The LED lighting assembly may be wired directly into the towing vehicle's backup lighting system or it may be provided with an on-off switch which may be positioned inside the tow vehicle or outside the tow vehicle near where the hitch is mounted on the vehicle.

Central to the present invention is a LED light housing which mounts to the shank of the trailer ball mount. The shank is inserted through an aperture in the light housing and the light housing is rigidly connected to the shank by means of bolts which are inserted through openings in the top of the light housing and screwed into corresponding threaded bolt holes in the upper surface of the shank. Once the light housing is secured to the shank the shank can be inserted into the hitch receiver and locked in place in the standard manner.

The light housing is preferably constructed from a metal, such as steel or aluminum. This provides a sturdy housing which protects the LED lights and additionally provides a step which allows the user to be able to step up and retrieve items from the back of the towing vehicle. To facilitate the use of the housing as a step a strip of non-slip material may be provided on the top surface of the housing.

### BRIEF DESCRIPTION OF THE DRAWINGS

FIG. 1 a perspective view of one embodiment of the present invention.

FIG. 2 is a top view of the light housing modular of the present invention.

FIG. 3 is a front view of the light housing modular of the present invention.

FIG. 4 is a rear perspective view of the light housing modular of the present invention.

FIG. 5 is the left side cross section view of the light housing modular.

FIG. 6 is a perspective view of the LED light.

FIG. 7 is a top view of a standard hitch aligned with the light housing module of the present invention.

FIG. 8 is a top view of the light housing modular of the present invention mounted on a standard hitch.

FIG. 9 is a side view of a dual ball hitch which can be used in connection with the subject invention.

FIG. 10 is a side view of a step down hitch that can be used in connection with the present invention.

FIG. 11. is a side view of a hitch element that can be used in connection with the step down hitch of FIG. 10.

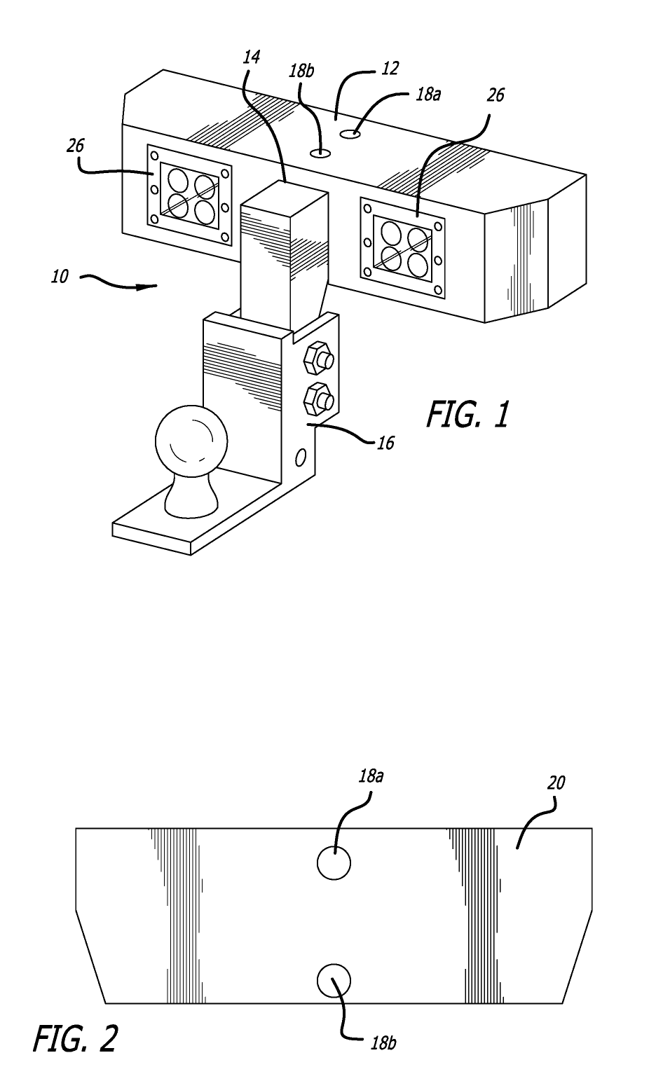

The lighted trailer hitch of the present invention is shown in FIG. 1. As shown, the trailer hitch 10 is comprised of a light module housing 12 mounted on the shank 14 of the trailer hitch 16. In the embodiment shown in FIG. 1, the trailer hitch is a step down hitch known to those skilled in the art.

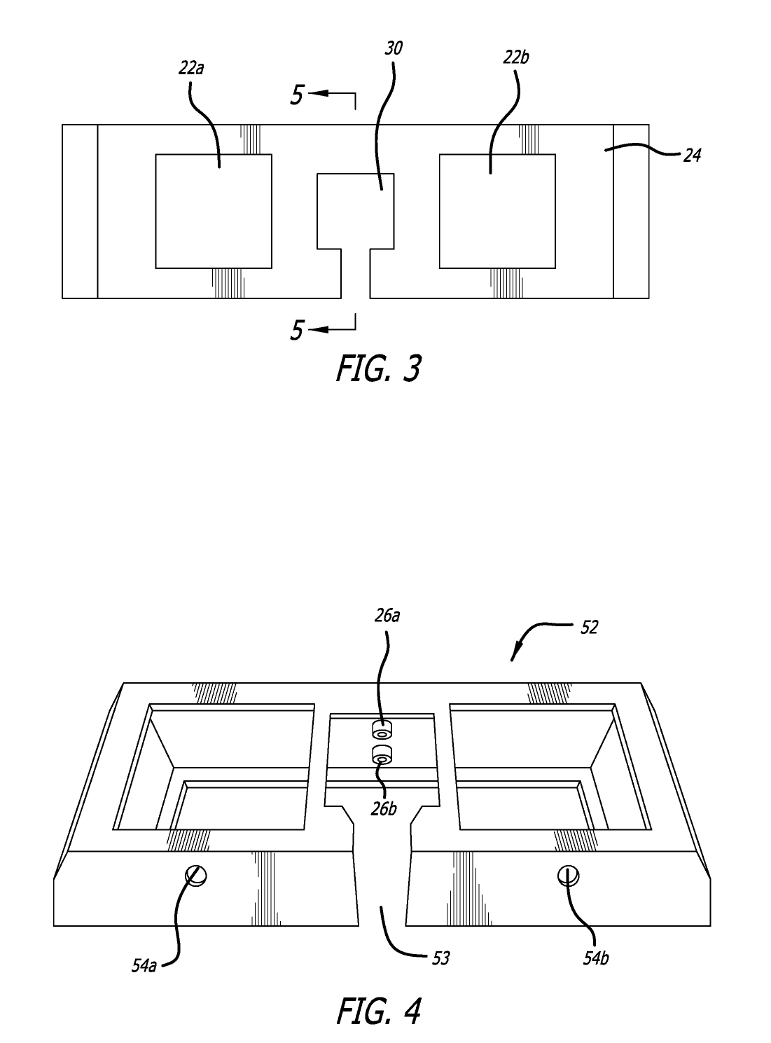

The light module housing 12 is shown in detail in FIGS. 2, 3 and 5. FIG. 2 shows the top profile of the housing. Mounting holes 18(a) and 18(b) are provided in the top surface 20 of the housing. FIG. 3 shows the front of the housing 12. Square opening 22(a) and 22(b) are provided in the front surface 24 of the housing. The lights 26 for the lighted trailer hitch of the subject invention are mounted within openings 22(a) and 22(b). Light 26 is shown in FIG. 6 outside of the light module housing 12. In the embodiment shown, the lights are square in shape, however, those skilled in the art will understand that circular or rectangular configured lights could also be utilized. In the preferred embodiment of the subject invention, the lights are LED lights.

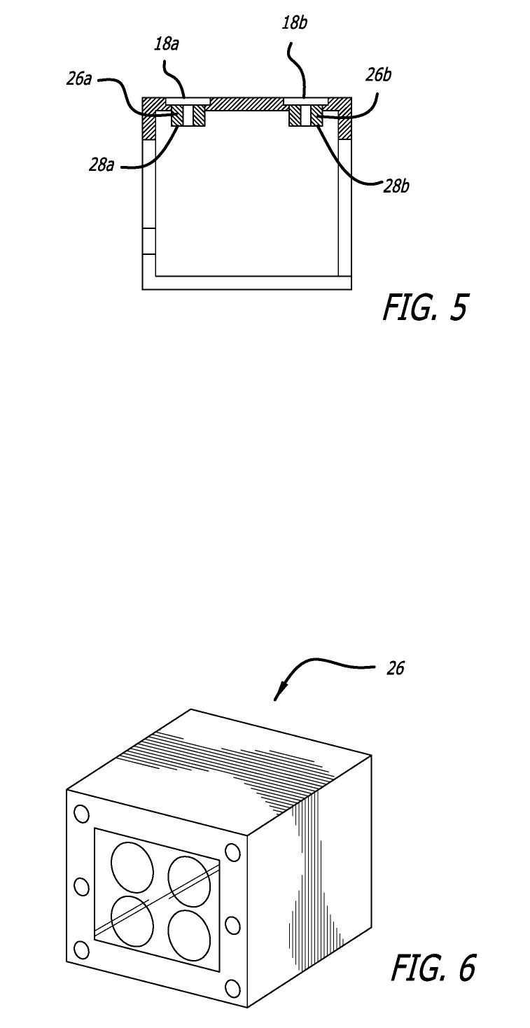

FIG. 5 shows a side cross-sectional view of the light module housing 12. As shown in FIG. 5 bolt holes 18(a) and 18(b) extend inward within housing 12 by means of cylindrical extensions 26(a) and 26(b). The bottom surface 28(a) and 28(b) of extension 26(a) and 26(b) contact the top surface of the trailer hitch shank 14 when the shank is inserted through aperture 30 (shown in FIG. 3) in the housing 12.

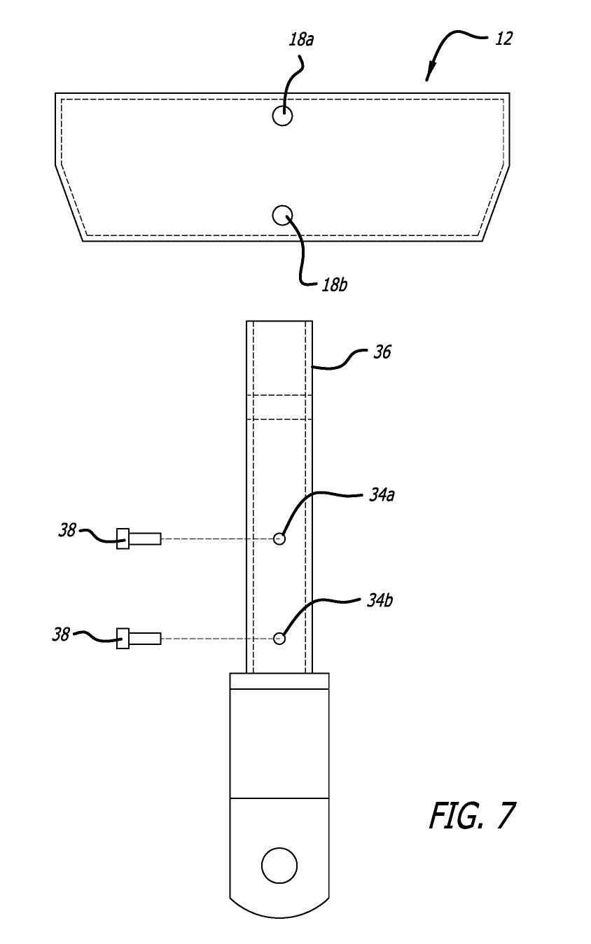

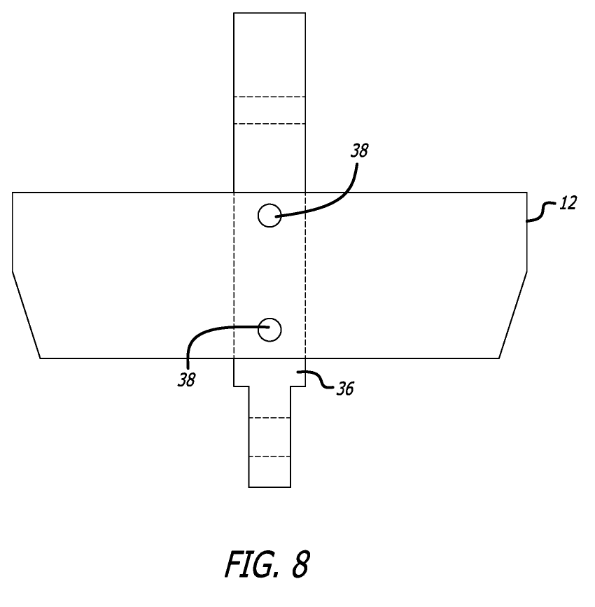

A standard ball hitch 32 is shown in FIG. 7. Threaded mounting holes 34(a) and 34(b) are provided in the upper surface of shank 36. When shank 36 is inserted through module 12 mounting holes 34(a) and 34(b) align with mounting holes 18(a) and 18(b). The light module housing is secured to the shank by means of mounting bolts 38. The trailer hitch is shown mounted within the light module housing 12 in FIG. 8.

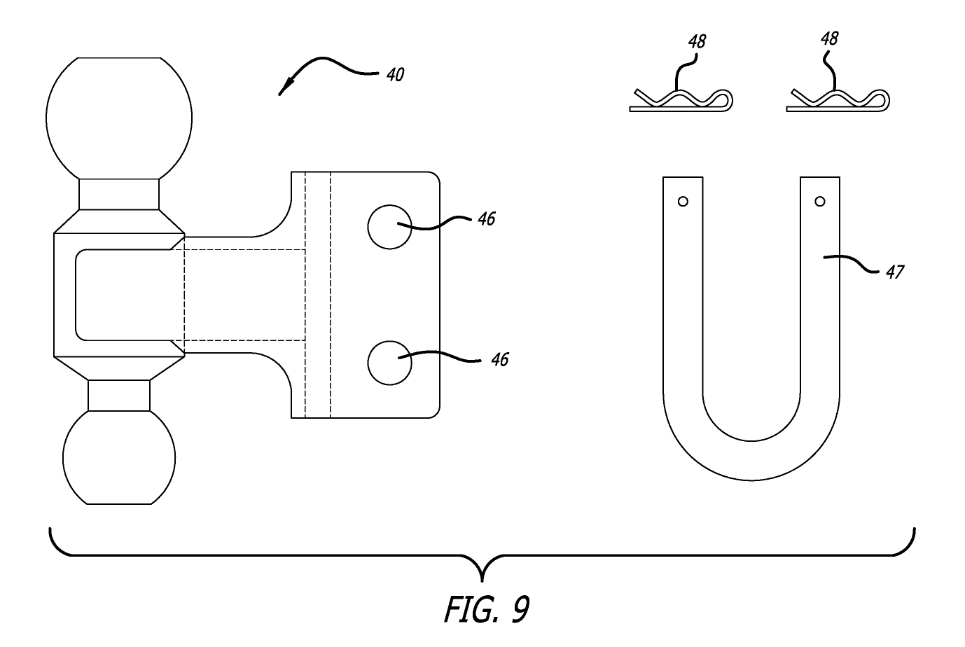

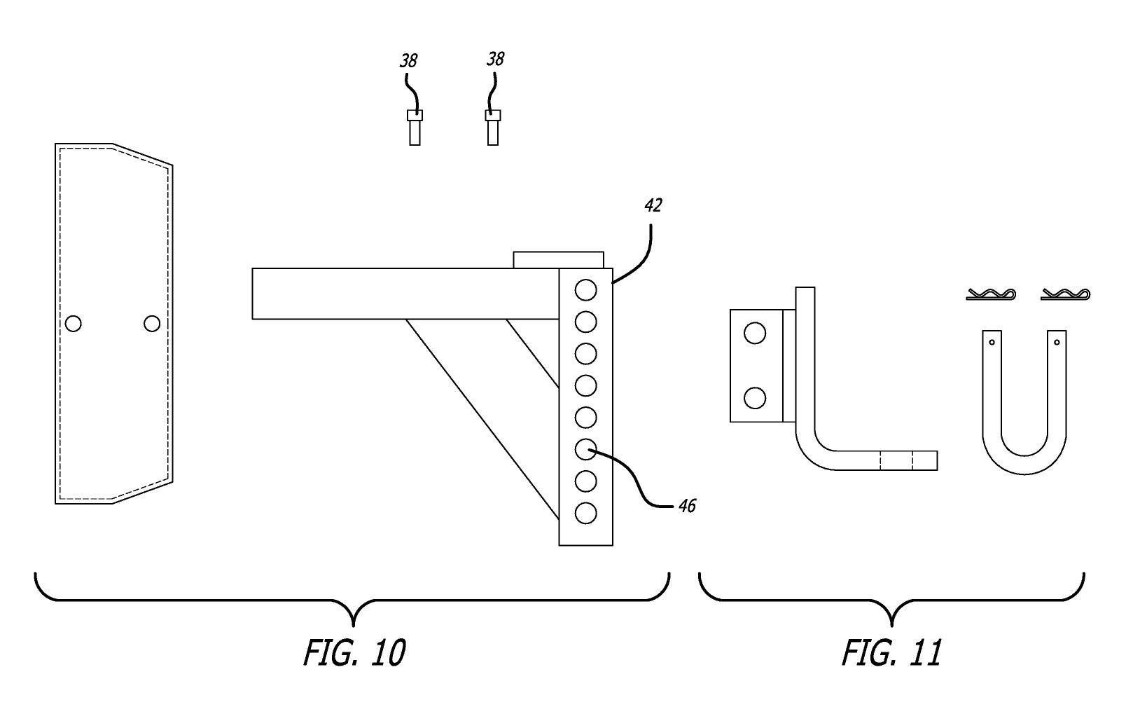

The light module housing 12 of the present invention can be used with trailer hitches of different types known to those skilled in the art. FIG. 9 shows a dual ball hitch attachment 40 that is typically utilized with a step down hitch. A step down hitch 42 is shown in FIG. 10. The step down hitch allows for adjustment of the height of the hitch ball to align with the height of the trailer tongue. As shown in FIG. 10 the vertical leg of the hitch 42 is provided with a plurality of apertures 44 extending through the leg. The user would align the apertures 46 on the dual ball hitch with the desired apertures on the vertical leg and then the u-shaped retaining bolt 47 would be inserted through the apertures 44 and hold in place by means of cotter pins 48.

As shown in FIG. 10 in the step down hitch a support bracket 50 is provided to strengthen the hitch and provide support to vertical leg 42. The use of a step down hitch requires the use of a modified light module housing as shown in FIG. 4. The modified light module housing 52 includes a slot cut 53 in the housing to accommodate support bracket 50 on the step down hitch. As shown in FIG. 4 the bottom of the housing 52 includes two apertures 54(a) and 54(b) and threaded into corresponding bolt holes located in the bottom of the light housing.

A different hitch attachment which can be used in connection with the subject invention is shown in FIG. 11. The L-shaped bracket is mounted on vertical leg 42 and held in place by means of U-shaped retaining bolt 47 and cotter pins 48.

The modular nature of the present invention allows for the user to utilize a single light module housing which is easily interchangeable with and can be used in connection with a variety of trailer hitches.

I claim:

1. A lighted trailer hitch assembly comprising:
a light housing module having one or more lights mounted therein,
an aperture provided in said housing;
wherein the shank of a trailer hitch is inserted through said aperture and into the receiver on the hitch; and
wiring means for connecting said light housing module to the electrical system of the tow vehicle
